(19) United States
(12) Patent Application Publication
(10) Pub. No.: US 2006/0112153 A1
(43) Pub. Date: May 25, 2006

(54) Export queue for an enterprise software system

(76) Inventor: David Stephen Lawrence Bowen, York (GB)

Correspondence Address: SHUMAKER & SIEFFERT, P. A., 8425 SEASONS PARKWAY, SUITE 105, ST. PAUL, MN, 55125, US

(21) Appl. No.: 10/996,855

(22) Filed: Nov. 22, 2004

(51) Int. Cl. G06F 17/30

(52) U.S. Cl. 707/204

(57) ABSTRACT

A large-scale enterprise software system is described that outputs consistent export data for concurrent exports. The system includes a database and an export control module. The database stores modeling data defining a plurality of nodes, and enterprise data associated within each of the nodes. The export control module outputs a portion of the enterprise data as export data in response to an export selection that associates a set of the nodes with a least one export client. During the export process, the export control module creates an archive (e.g., a copy) of the enterprise data associated with one or more of the nodes for the export selection prior to modifying the enterprise data. The export control module utilizes the current enterprise data for the non-modified nodes and the archived export data for the nodes that were modified during the export process to output consistent export data for multiple, concurrent export clients.

### TECHNICAL FIELD

The invention relates to software systems and, in particular, techniques for exporting data from an enterprise software system.

### BACKGROUND

Enterprise software systems are typically sophisticated, large-scale systems that support many, e.g., hundreds or thousands, of concurrent users. Examples of enterprise software systems include financial planning systems, budget planning systems, order management systems, inventory management systems, sales force management systems, business intelligent tools, enterprise reporting tools, project and resource management systems and other enterprise software systems.

In many situations, a user may wish to export data from an enterprise software system. As one example, the user may wish to export data from a financial planning system to a reporting system. In these situations, it is often required to provide a “consistent export” in which the exported data correctly reflects the state of the enterprise data at the time the exported is initiated. For example, an update or other data change during export may result in inconsistent data in that the update cannot be propagated to the portion of the enterprise data already exported. As a result, only a portion of the data may reflect the update, while the previously exported data may reflect a state prior to the update.

One conventional approach taken by enterprise software systems has been to “freeze” or “lock down” the entire enterprise software system in order to export consistent data. As one example, some software systems must be brought offline before any export can be initiated. In this manner, the enterprise software systems seek to prevent any updates or data changes during the export process.

The export process, however, may be time consuming, and it may be undesirable to lock out the enterprise users for a period of time. Consequently, some enterprise software systems seek to minimize the time during which the system is offline by defining a “staging area.” When an export process is initiated, the enterprise software system takes a snapshot of the data to be exported, and copies the snapshot to the staging area. This approach may reduce the amount of time users are locked out of the system; however, the approach does not work well when multiple, concurrent exports are required. Moreover, the amount of data to be exported may be significant, and the physical resources spent in copying the data to form the snapshot may be considerable.

### SUMMARY

In general, the invention is directed to techniques for exporting data from a software system, such as an enterprise software system. Specifically, the techniques provide for the export of a consistent set of data from the software system. Moreover, the techniques provide consistent data even with multiple, concurrent exports.

In one embodiment, a system comprises a database, one or more enterprise software modules and an export control module. The database stores modeling data defining a plurality of nodes, and enterprise data associated within each of the nodes. The enterprise software modules access the database and modify the enterprise data. The export control module receives an export selection that designates a set of the nodes, and outputs the enterprise data associated with the designated set of nodes as export data in response to export selection. Prior to modifying the enterprise data for any of the nodes, the enterprise software modules create an archive of the enterprise data for the node to be modified when the node is designated by the export selection. The export control module utilizes the archived enterprise data to output consistent export data.

In another embodiment, a method comprises storing modeling data defining a set of nodes of an enterprise, wherein each node has associated enterprise data, and storing export control data that defines an export selection, wherein the export selection associates a set of the nodes with at least one export client. The method further comprises receiving a request to update the enterprise data associated with one of the nodes, creating an archive of the enterprise data for the requested one of the nodes, and outputting consistent export data for the export selection based on the non-updated enterprise data and the archived enterprise data.

In another embodiment, a computer-readable medium comprises instructions to cause a processor to store modeling data defining a set of nodes of an enterprise and export control data that defines an export selection. Each node has associated enterprise data, and the export selection associates a set of the nodes with at least one export client. The instructions further cause the processor to receive a request to update the enterprise data associated with one of the nodes, create an archive of the enterprise data for the requested one of the nodes, and output consistent export data for the export selection based on the non-updated enterprise data and the archived enterprise data.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating an example computing environment in which a plurality of users interact with an enterprise planning system that enables and automates the reconciliation of top-down targets with detailed bottom-up forecasts.

FIG. 2 is a block diagram illustrating one example embodiment of the enterprise planning system in further detail.

FIG. 3 is a block diagram illustrating an example data organization model for export control data for controlling the consistent export of data from the enterprise planning system.

FIG. 4 is a flowchart illustrating exemplary operation of an export control module that exports the consistent data.

### DETAILED DESCRIPTION

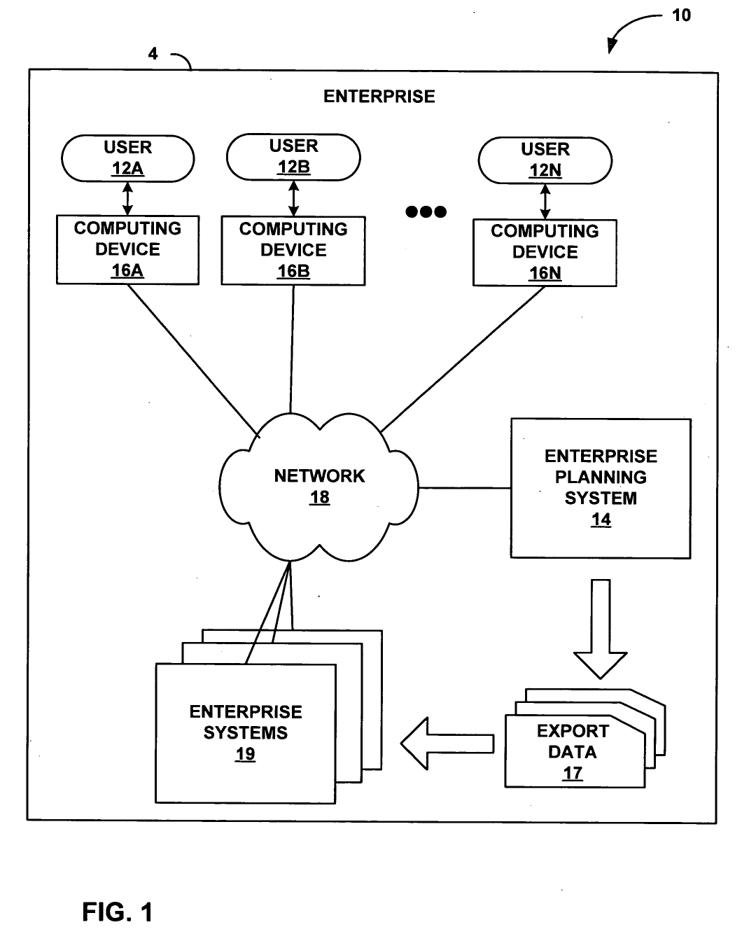

FIG. 1 is a block diagram illustrating an example computing environment 10 in which a plurality of users 12A-12N (collectively, “users 12”) interact with an enterprise planning system 14. In the system shown in FIG. 1, enterprise system 14 is communicatively coupled to a number of computing devices 16A-16E (collectively, “computing devices 16”) by a network 18. Users 12 interact with their respective computing devices 16 to access enterprise planning system 14.

For exemplary purposes, the invention is described in reference to an enterprise planning system, such as an enterprise financial or budget planning system. The techniques described herein may be readily applied other software systems, including other large-scale enterprise software systems. Examples of other enterprise software systems include order management systems, inventory management systems, sales force management systems, business intelligent tools, enterprise reporting tools, project and resource management systems and other enterprise software systems.

In general, enterprise planning system 14 enables and automates the reconciliation of top-down targets with detailed bottom-up forecasts for an enterprise. Enterprise planning system 14 implements and manages an enterprise planning process, which generally consists of three functions: (1) modeling, (2) contribution and (3) reconciliation.

Initially, high-level enterprise managers or executives, referred to as analysts, define organizational targets, and build planning models for the enterprise. The analysts may include, for example, financial analysts, such as the chief financial officer, senior financial analysts or product and sales analysts. More specifically, the analysts develop a model having a number of hierarchically arranged nodes representing various cost centers within the organization, such as business units or departments. The analysts then specify corporate target data for each node of the organizational hierarchy. Corporate target data may include financial data, revenue data, order data, inventory data, and the like, depending on the particular enterprise planning activity being carried out by the enterprise. The analysts then assign one or more enterprise users 12 to each node, such as managers, supervisors, sales representatives, lab managers, or the like, that are responsible for enterprise planning for the cost center corresponding to the node. Each enterprise user 12 may be designated as a contributor that provides planning data to enterprise planning system 14, a reviewer that accepts or rejects contributions from the contributors, or both. The contributors and reviewers may be authorized users within the enterprise or within other entities coupled to network 18, such as suppliers or customers.

The enterprise users 12 that are designated as contributors interact with enterprise planning system 14 to input detailed forecasts in the form of contribution data. As described above, enterprise users 12 may provide detailed financial forecasts, revenue forecasts, order forecasts, inventory forecasts, estimated resource requirements, and the like, depending on the particular enterprise planning activity being carried out by the enterprise.

Enterprise planning system 14 automates the reconciliation of the forecast data with the corporate target data provided by the analysts. In particular, enterprise planning system 14 operates in accordance with a defined model, i.e., the enterprise planning model created by the analysts, to provide a hierarchical planning process having multiple reconciliation levels. As each of the contributors provides his or her contribution data (referred to generally, as “enterprise data”), enterprise planning system 14 automatically aggregates the contribution data across the enterprise in real-time, and provides access to the aggregated data to enterprise users 12 designated as reviewers associated with higher levels of the enterprise. In particular, upon receiving contribution data from the contributors, enterprise planning system 14 identifies all higher levels of the organizational model affected by the newly received contribution data, and calculates new aggregate totals at each level in real-time.

Consequently, the reviewers view aggregated data across the enterprise in real-time during the enterprise planning session. At each level, enterprise planning system 14 ensures that the reviewers, as defined by the nodes of the enterprise model, reconcile the target data with the forecast data. Each of the reviewers may, for example, reject or accept the contribution data in view of corporate targets provided by the analysts. This process continues until the contribution data is ultimately approved by the highest level of the organizational hierarchy, thereby ensuring that the contribution data from the contributors reconciles with corporate targets provided by the analysts.

In this manner, enterprise planning system 14 may provide more accurate enterprise planning than with conventional techniques. For example, enterprise planning system 14 may improve the accuracy and predictability of enterprise planning by enabling organizations to reconcile corporate models and organizational targets with detailed forecasts. The techniques may provide a platform that delivers collaborative, real-time planning capabilities, without requiring offline consolidation and aggregation of forecasts. Because enterprise planning system 14 can aggregate contribution data in real-time, all users 12 can be presented with an accurate, up-to-date view of the numbers. Further, the architecture of enterprise planning system 14 can readily scale to thousands of users, and may be designed around best planning practices. In addition, the techniques enabling high participation by enterprise users 12, i.e., the contributors and reviewers, allowing accurate planning cycles to be reduced.

Enterprise users 12 may use a variety of computing devices to interact with enterprise planning system 14 via network 18. For example, an enterprise user may interact with enterprise planning system 14 using a laptop computer, desktop computer, or the like, running a web browser, such as Internet Explorer™ from Microsoft Corporation of Redmond, Wash. Alternatively, an enterprise user may use a personal digital assistant (PDA), such as a Palm™ organizer from Palm Inc. of Santa Clara, Calif., a web-enabled cellular phone, or similar device.

Network 18 represents any communication network, such as a packet-based digital network like the Internet. In this manner, system 10 can readily scale to suit large enterprises. Enterprise users 12 may directly access enterprise planning system 14 via a local area network, or may remotely access enterprise planning system 14 via a virtual private network, remote dial-up, or similar remote access communication mechanism.

Enterprise planning system 14 may utilize a “cut-down” process by which the multidimensional data store is “sliced” for each user 12 in accordance with the defined enterprise model. During this process, enterprise planning system 14 identifies areas of the defined model to which users 12 are assigned, either as contributors or reviewers, and “slices” the data store based on the assignments. When a given user 12 logs in and proceeds with an enterprise planning activity, enterprise planning system 14 communicates the respective data slice to the respective computing device 16 for display to the user via the extended spreadsheet application. In this fashion, enterprise planning system 14 need not communicate the entire model to each of users 12, thereby reducing communication time as well as resource requirements. Instead, each user 12 receives only relevant information. Users 12 interact with computing devices 16 to capture contribution data, and to reconcile the contribution data with organizational targets.

As described herein, enterprise planning system 14 provides an export interface for exporting data. Specifically, enterprise planning system 14 provides consistent sets of exported data 17 that may be utilized, for example, by other enterprise software systems 19. Moreover, enterprise planning system 14 provides consistent exported data 17 even when multiple, concurrent exports are requested and initiated.

Enterprise planning system 14 presents a user interface by which any of users 12 can initiate an export of the planning data maintained by enterprise planning system 14. In addition, enterprise planning system 14 provides an application programming interface (API) by which the export process may be automatically initiated, e.g., via an automated agent or any of enterprise software systems 19.

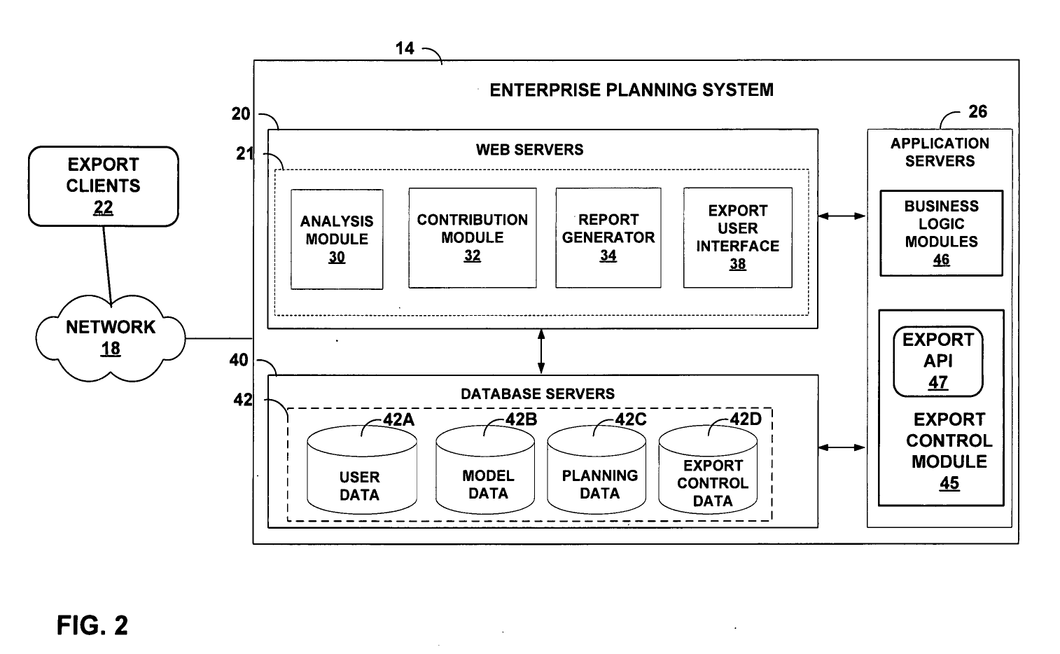

FIG. 2 is a block diagram illustrating one embodiment of enterprise planning system 14 in further detail. In the illustrated example, enterprise planning system 14 includes web servers 20, application servers 26 and database servers 40.

Web servers 20 provide an interface for communicating with export clients 22 via network 18. Web servers 20 execute web server software, such as Internet Information Server™ from Microsoft Corporation, of Redmond, Wash. As such, web servers 20 provide an environment for interacting with contributors, analysts, and reviewers according to software modules 21, which include analysis module 30, contribution module 32, report generator 34 and export user interface 38.

Software modules 21 typically take the form of instructions stored on computer-readable media for execution by one or more processors. Software modules 21 may comprise Visual Basic modules, Java scripts, Java Applets, Active Server Pages, web pages written in hypertext markup language (HTML) or dynamic HTML, Active X objects and other suitable modules. Web servers 20 serve up web pages defined by software modules 21, and communicate the web pages to computing devices of enterprise users 12. The web pages may include static media, such as text and graphic imagery, as well as conventional input media such as text entry boxes, radio buttons, drop-down menus, and the like, for receiving information from enterprise users 12.

Software modules 21 interact with database servers 40 to access enterprise data 42 including user data 42A, model data 42B, planning data 42C and export control data 42D. Enterprise data may be stored in a number of different forms including one or more data storage files, or one or more database management systems (DBMS) executing on one or more database servers. Furthermore, although illustrated separately, enterprise data 42 could be combined into a single database or other data storage structure. Enterprise data 42 could, for example, be implemented as a single relational database, such as SQL Server from Microsoft Corporation.

User data 42A stores information for each of users 12, including the name, email address, and other contact information for the user. Model data 42B stores the enterprise planning models defined by analysts. For example, model database 42B stores information that defines the reconciliation process developed by the analysts, including the number of reconciliation levels, the various “nodes” in the hierarchy, and a contributor associated with each node. Planning data 42C stores the actual contribution data (i.e., “enterprise data”) for each of the nodes for one or more planning sessions. As further described below, export control data 42C stores data related to export selections specified by export clients 22. Export clients 22 may, for example, be any of a user 12, an automated agent or any of enterprise systems 19.

Referring again to software applications 21, analysis module 30 includes one or more software modules for creating enterprise planning models, such as financial models for enterprise 4, to control the entire planning process. Contribution module 32 includes software modules for presenting a contribution interface for capturing contribution data from the contributors. Contribution module 32 captures and aggregates the contribution data across enterprise 4 in real-time, and provides access to the aggregated data to reviewers associated with higher levels of enterprise 4.

Report generator 34 includes analytical software modules that generate enterprise planning reports based on the contribution data received from the contributors and stored within planning data 42C. In particular, the analytical software modules allow users 12 to formulate complex queries for generating reports and performing other data analysis functions on the current data of the enterprise model. These software modules may be web-based modules having a browser interface, or may be stand-alone executable programs.

Business logic modules 46 execute within the operating environment provided by application severs 26, and provide functionality for accessing and processing the data stored within databases 42 in response to software modules 21. In particular, business logic modules 46 comprise software routines for implementing the enterprise planning functions, and are invoked by software modules 21.

Export control module 45 controls the export of consistent data from planning data 42C based on export selections initiated by export clients 22. Specifically, export control module 45 receives export selections from export clients 22 that designate all or portions of planning data 42C. A selection may, for example, specify one or more nodes of the planning model defined by model data 42B and request exportation of the current planning data associated with each of the specified nodes. Export control module 45 updates planning data 42C and export control data 42D to record the selection, and provides a consistent export of the data when requested.

Export control module 45 provides export application programming interface (API) 47 with which export clients 22 may directly request and retrieve consistent export of planning data. Alternatively, export user interface 38 provides a manual mechanism for invoking export API 47. Specifically, a human export client 22 (e.g., a user 12) may interact with export user interface 38 to manually designate one or more nodes and initiate the export process. In this case, export user interface 38 in turn calls export API 47 to engage export control module 45. Alternatively, an export client 22 may directly invoke export API 47. In this case, the export client 22 may be an automated software agent or any of enterprise systems 19.

In one embodiment, export API 47 exposes the methods listed in TABLE 1 for interacting with export control module 45.

TABLE 1

| METHOD | OPERATION |
|---|---|
| createExportClient(Guid, | Registers the export client for exporting |
| node list) | data from the list of nodes using the global |
| | unique identifier (GUID). |
| removeExportClient(Guid) | Unregisters the export client. |
| export (Guid, . . ., Guid) | Creates an export selection associated with |
| | one or more of the registered export |
| | clients. Returns a handle unique to the |
| | created export selection. |
| exportSelectionInfo(handle) | Returns a selection version for the created |
| | export selection. |
| dataForNode(nodeID, | Retrieves export data for the specified |
| minimum version number) | node based on the minimum version |
| | number. |
| exportClientComplete(Guid, | Indicates that the specified export client |
| selection handle) | has finished exporting data for a selection. |

The method createExportClient receives a unique identifier (e.g., a Global Unique Identifier) that uniquely identifies an export client 22. In addition, the parameter set for createExportClient identifies a set of nodes of planning data 42C from which the requesting export client 22 wishes to export data. Export control module 45 updates export control data 42D to record the unique identifier as a possible export client and the identified nodes. The method removeExportClient causes export control module 45 to unregister the export client.

The method export has a parameter set that includes one or more unique identifiers associated with previously registered export clients 22. Specifically, export control module 45 updates export control data 42D to associate the set of unique identifiers with a common “export selection.” In other words, export control module 45 ensures that each of the export clients 22 specified within the export method receives the same (i.e., identical) consistent export data. These or other export clients 22 may subsequently invoke the export method to create additional export selections, where each export selection is associated with different sets of consistent export data.

As described in detail below, export clients 22 invoke the method dataForNode to retrieve the export data associated with a particular export selection for a particular node of the model. Once an export client 22 has retrieved all of the desired export data for a given export selection, the export client invokes exportClientComplete. When all of the export clients 22 associated with an export selection have indicated that the export process is complete, export control module 45 may apply a housekeeping process to free resources.

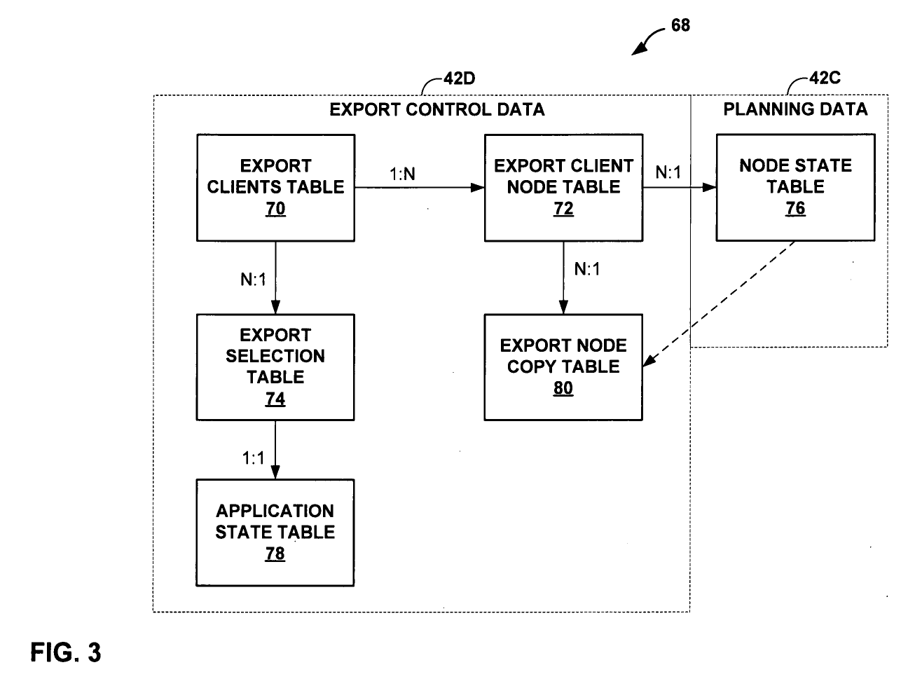

FIG. 3 is a block diagram illustrating an example data organization model 68 for export control data 42D. In this example, export control data 42D comprises a plurality of database tables.

Export clients table 70 stores data identifying registered export clients 22. Export clients table 70 includes a plurality of rows and columns, as is typical in relational databases. Each row associates a registered export client 22 with an export selection. In one embodiment, each row stores the unique identifier for the respective export client 22, a client name and a unique identifier associated with the particular export selection. In this manner, the client identifier and the selection identifier within the row associate the identified export client with a particular export selection. The client name may be useful in applications where two processes share the export client without communicating the client identifier.

Export selection table 74 stores data describing the particular export selections. In one embodiment, each row corresponds to a different export selection, and includes a unique selection identifier and a selection version. The selection version is an integer that is increased as export selections are defined, and is used to track the particular version of consistent data associated with each export selection. As illustrated in FIG. 3, export clients table 70 has a N:1 relationship with export selection table 74, indicating that any N rows (i.e., export clients) within the export clients table 70 may be associated with any single row of export selection table 74. In this manner, multiple export clients 22 may be associated with the same export selection.

Export client node table 72 stores data associating registered export clients with nodes within the planning model for which data is to be exported. In one embodiment, each row of export client node table 72 includes an identifier of a registered export client 22 and an identifier for a node within the planning model, as defined by planning data 42C. As new export clients are created and removed (i.e., via the createExportClient and removeExportClient methods), export control module 45 updates the entries in export client node table 72. In the exemplary embodiment, export client node table 70 has a 1:N relationship with export client node table 72, indicating that any export client registered within the export clients table 70 may be associated with any N nodes of the planning model.

Node state table 76 stores the actual planning data associated with each node, i.e., planning data 42C of FIG. 2. In one embodiment, each row is associated with a different node, and stores data for that particular node as an XML string. Further each, row includes one or more “archive” flags (e.g., bits) that indicate whether an archive (i.e., backup copy) must be made for the planning data prior to update. Specifically, the archive flag is used to identify whether any export clients have designated the node as a target for an export selection and, therefore, that the planning data must be archived prior to change. In this manner, the archived planning data may be used to satisfy the export of a consistent data set associated with the export selection. Export client node table 72 has a N:1 relationship with node state table 76 in that each node of the node state table may be associated with multiple clients via the export client node table.

Export node copy table 80 stores archived copies of data for those nodes that are currently associated with an export process and that have original data (i.e., data stored within node state table 76) that has been modified. In other words, prior to modifying original planning data 42C, software modules 21 check the archive flags in node state table 76 and, if set, archive the current data to export node copy table. Software modules 21 may, for example, archive the current data directly to node copy table, or may invoke export control module 45 to archive the data. In one embodiment, each row of node copy table 80 includes a node identifier, a selection version, the archived data, and a flag that is used to ensure the archive is complete before the current planning data for the node is modified.

Application state table 78 stores metadata that describes the state of enterprise planning system 14 at the time each export selection was created. For example, the stored metadata may cache all or portions of model data 42B for use in properly analyzing the exported data. In this manner, export clients 22 may utilize the metadata to reconstruct the model for processing (e.g., analyzing and reporting) the exported data.

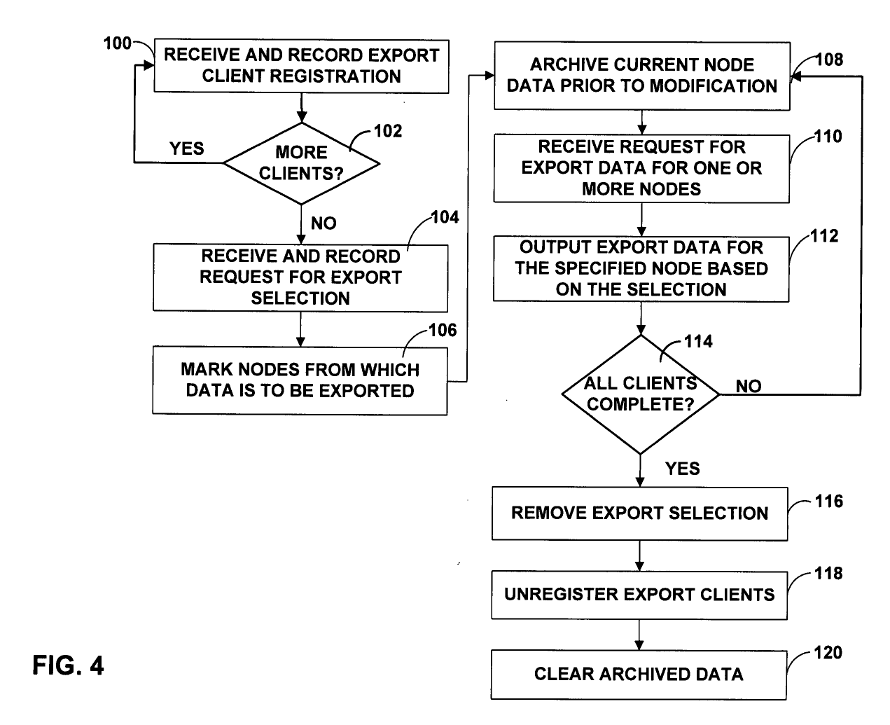

FIG. 4 is a flowchart illustrating exemplary operation of export control module 45. Initially, export control module 45 receives and records registration for an export client 22 (100). The export client 22 may, for example, invoke export client module 45 via the createExportClient method exposed by export API 47. Export control module 45 registers the export client by updating export clients table 70 to record the unique identifier of the particular export client 22 being registered, and updates export client node table 72 to associate the export client with the identified nodes from which data is to be exported. This process may continue for a period of time during which multiple export clients 22 may be registered (100, 102).

At any point, a registered export client 22 may specify an export selection and initiate the export process (104). The export client 22 may, for example, invoke the export method and specify one or more export clients for association with the export selection.

In response, export control module 45 accesses export client node table 72 to identify all of the nodes from which data is to be exported for the set of export clients specified within the export method. Export control module 45 then traverses node state table 76 and sets the archive flag for each of the nodes to indicate that the node has been designated for export (106). In one embodiment, export control module 45 maintains two flags within each row of node state table 76 to ensure consistent data. In particular, export control module 45 maintains a “soon to be set” flag for each designated node. Once the “soon to be set” flags for each node are set, export control module 45 copies the “soon to be set” flags to the archive flag for each row in a single atomic operation. In this manner, export control module 45 prevents any data update from occurring while the archive flags for the designated nodes are being set. In addition, export control module 45 increments the current selection version.

Next, enterprise planning system 14 operates in normal fashion, i.e., continues the enterprise planning session in this example. During this process, users 12 may issue requests to update planning data 42C for any of the nodes of the planning model, including nodes associated with one or more export selections. When processing an update, software modules 21 first check whether the archive flag has been set within node state data table 76 for the specific node being updated. If the archive flag is set, software modules 21 archive the current planning data for that node to export node copy table 80 and, once the archive is complete, modify the current planning data within node state data table 76 (108). When archiving the planning data for a given node, software modules 21 update a pre-created entry within export node copy table 80 to store the planning data for the current selection version. Software modules 21 may directly write to export node copy table 80, or may invoke export control module 45 to archive the data.

Although not shown in FIG. 4, at any point one or more subsequent export selections may also be initiated. Export control module 45 processes these export selections as described, and increments the current selection version upon receiving each export request. Moreover, once an archive is created, its recorded selection version does not change. As a result, the entries in export node copy table 80 storing the archived planning data may have increasing selection versions.

At a subsequent point within the planning process, export control module 45 may receive a request to export data for an export selection and, in particular, a node associated with the export selection (110). In particular, an export client 22 may invoke the dataForNode method, specifying a particular node and a handle (i.e., reference) to an export selection.

In response, export control module 45 selectively outputs planning data from either node state table 76 or export node copy table 80 depending upon whether the planning data for the requested node had been archived due to a modification request (112). In the event the planning data for the node has not been archived, then export control module 45 retrieves the current planning data from export node state table 76. However, in the event planning data from the node has been archived, export control module 45 determines whether the archived planning data has a version equal to or exceeding the version of the current export selection being serviced. If so, export control module 45 retrieves the archived planning data from export node copy table 80 as the archived planning data represents the state of the planning data at the time the export selection was created. If, however, the archived planning data has a version that is less than the version associated with the export selection, then the archived planning data is “older” than planning data at the time the export selection was created. In this manner, export control module 45 retrieves the oldest valid version of the archived planning data. If no archived planning data entry exists with a version that equals or exceeds the version associated with the export selection, export control module 45 retrieves the current planning data from export node state table 76.

This process continues until all export clients 22 associated with a particular export selection have retrieved the desired export data and indicated completion of the export process, e.g., via calling exportClientComplete (114). Once all clients are complete, export control module 45 updates export selection table 74 to remove the export selection (116), unregisters the export clients (118) and processes export node copy table 76 to remove any archived data that no longer needs to be maintained, i.e., archived data for nodes no longer associated with any export selection (120).

Various embodiments of the invention have been described. Although described in reference to an enterprise planning system, such as an enterprise financial or budget planning system, the techniques may be readily applied to other software systems, including other large-scale enterprise software systems. Examples of other enterprise software systems include order management systems, inventory management systems, sales force management systems, business intelligent tools, enterprise reporting tools, project and resource management systems and other enterprise software systems. Moreover, the techniques may be implemented on any type of computing device, including servers, client computers, laptops or other devices. These and other embodiments are within the scope of the following claims.

1. A method for exporting data from a software system comprising:
storing modeling data defining a set of nodes of an enterprise, wherein each node has associated enterprise data;
storing export control data that defines an export selection, wherein the export selection associates a set of the nodes with at least one export client;
receiving a request to update the enterprise data associated with one of the nodes;
creating an archive of the enterprise data associated with the node to be updated; and
outputting consistent export data for the export selection based on the non-updated enterprise data and the archived enterprise data.

2. The method of claim 1, further comprising:
assigning a version to the export selection; and
recording the version with the archive of the enterprise data when the archive of the enterprise data is created.

3. The method of claim 2, wherein outputting consistent export data comprises selectively outputting the non-updated enterprise data or the archived enterprise data based on the version recorded with the archive.

4. The method of claim 2, wherein the export selection comprises a first export selection and the version comprises a first version, the method further comprising:
receiving requests for additional export selections;
updating the export control data to define the additional export selections; and
assigning a new version to each of the additional export selections.

5. The method of claim 4, wherein recording the version comprises recording the most recent version to the archive of enterprise data when the archive of enterprise data is created.

6. The method of claim 5, wherein outputting consistent export data for the first export selection comprises outputting the archived enterprise data when the version recorded for the archived enterprise data is equal to or exceeds the version assigned to the first export selection.

7. The method of claim 6, wherein outputting consistent export data for the first export selection further comprises outputting the non-updated enterprise data for the remaining nodes associated with the export selection.

8. The method of claim 1, wherein creating an archive of the enterprise data comprises storing the enterprise data within a database.

9. The method of claim 8, further comprising storing the archived enterprise data as one of a plurality of entries sorted by selection versions, wherein the selection versions correspond to different export selections.

10. The method of claim 1, further comprising:
receiving requests for concurrent consistent exports of the enterprise data; and
updating the control data to define the a plurality of export selections, each of the export selections corresponding to a different one of the concurrent consistent exports.

11. The method of claim 1, wherein the software system comprises an enterprise planning system and the enterprise data comprises enterprise planning data.

12. A system comprising:
a database system storing modeling data defining a plurality of nodes, and enterprise data associated within each of the nodes;
one or more enterprise software modules that access the database and modify the enterprise data;
an export control module that receives an export selection that designates a set of the nodes, and outputs the enterprise data associated with the designated set of nodes as export data in response to export selection,
wherein prior to modifying the enterprise data for any of the nodes, the enterprise software modules create an archive of the enterprise data for the node to be modified when the node is designated by the export selection.

13. The system of claim 12, wherein the enterprise software module invokes the export control module to create the archive.

14. The system of claim 12, wherein the export control module includes an application programming interface by which an export client specifies the export selection.

15. The system of claims 14, wherein the export client is one of the enterprise software modules.

16. The system of claim 12, wherein export control module maintains export control data within the database to define the export selection.

17. The system of claim 12, wherein the export control module includes an application programming interface by which the requesting enterprise software module receives the export data.

18. The system of claim 12, wherein the export control module outputs the export data to selectively include the non-updated enterprise data or the archived enterprise data.

19. The system of claim 12, wherein the export control module assigns a version to the export selection, and records the version with the archived enterprise data.

20. The system of claim 12, wherein the export control module archives the enterprise data by writing a copy of the enterprise data to a table within the database, wherein an entry of the table stores archived enterprise data for one of the nodes of the export selection for which a modification has occurred.

21. The system of claim 20, wherein the export control module receives requests for multiple export selections, and assigns a different version to each of the additional export selections.

22. The system of claim 21, wherein when archiving the enterprise data, the export control module records the current version at the time the modification is requested.

23. The system of claim 12, wherein the database further comprises:
an export clients table to store data defining a plurality of export clients;
an export selection table to store data defining the export selection;
an export client node table to store data mapping export clients to the nodes; and
an export node copy table to store the archived enterprise data for each of the nodes of the export selection for which a modification is requested.

24. The system of claim 12, wherein the export control module receives a request for the export selection and marks the nodes associated with the export selection to indicate that the enterprise data is to be archived prior to modification nodes.

25. The system of claim 12, wherein the software system is an enterprise planning system and the enterprise data comprises enterprise planning data.

26. A system comprising:
an enterprise planning system that maintains multidimensional data associated with an enterprise planning session in accordance with an enterprise model having a plurality of nodes;
a computing device coupled to the enterprise planning system via a network, wherein a user interacts with the computing device to participate in the enterprise planning session,
wherein the enterprise planning system outputs consistent export data for a plurality of concurrent export selections that identify non-identical sets of the nodes from which to export data.

27. The system of claim 26, wherein the enterprise planning system comprises:
a database system storing: (i) modeling data defining the model and the plurality of nodes, and (ii) enterprise data associated within each of the nodes; and
an export control module that outputs a portion of the enterprise data as the export data for each of the export selection.

28. The system of claim 27, wherein the export control module creates an archive of the enterprise data associated with one or more of the nodes for the export selection prior to modifying the enterprise data.

29. A computer readable medium comprising instruction that cause a programmable processor of a computing device to:
store modeling data defining a set of nodes of an enterprise, wherein each node has associated enterprise data;
store export control data that defines an export selection, wherein the export selection associates a set of the nodes with at least one export client;
receive a request to update the enterprise data associated with one of the nodes;
create an archive of the enterprise data for the requested one of the nodes; and
output consistent export data for the export selection based on the non-updated enterprise data and the archived enterprise data.
